(19) United States
(12) Patent Application Publication
(10) Pub. No.: US 2014/0306933 A1
(43) Pub. Date: Oct. 16, 2014

(54) LIGHT GUIDE PLATE TOUCH DEVICE

(71) Applicant: Era Optoelectronics Inc., New Taipei City (TW)

(72) Inventor: CHIH-HSIUNG LIN, New Taipei City (TW)

(73) Assignee: Era Optoelectronics Inc., New Taipei City (TW)

(21) Appl. No.: 14/249,552

(22) Filed: Apr. 10, 2014

(30) Foreign Application Priority Data
Apr. 15, 2013 (TW) 102113220

(51) Int. Cl. G06F 3/042

(52) U.S. Cl. CPC G06F 3/042
USPC 345/175

(57) ABSTRACT

A light guide plate touch device comprises a light guide plate, a sensitive unit array, a light emitting unit and a microprocessor; an end of the sensitive unit array is disposed next to the light emitting unit; the light emitted from the light emitting unit is guided into the light guide plate to proceed total reflective propagation; the microprocessor detects multiple signals received by all the sensitive units, compares the signals to confirm attenuated signal of the frustrated total internal reflection resulting from an object touching the light guide plate and then to confirm at least two sensitive units sensing the attenuated signal, obtains position information of a touch point where the object touches the upper surface of the light guide plate according to positions of at least two sensitive units, and outputs a corresponding touch-control signal; Accordingly, the respective number of the light sources and the sensitive units are reduced to lower production expense and cost.

### CROSS-REFERENCE TO RELATED APPLICATIONS

The application claims priority from Taiwan Patent Application No. 102113220 filed on Apr. 15, 2013, the disclosure of which is incorporated herein by reference.

### BACKGROUND OF THE INVENTION

1. Field of the Invention

The present invention relates to a touch device, and, more particularly, to a touch device with which position of frustrated total internal reflection of light propagation in a light guide plate is detected to generate a corresponding control signal.

2. Description of Related Art

There are many touch devices in association with light guide plates; for instance, U.S. Pat. No. 7,432,893 discloses an input device based on frustrated total internal reflection (FTIR) in which lights emitted from at least two light sources in different positions are guided into a light guide plate to allow the light to proceed propagation with total internal reflection in the light guide plate, wherein light from each light source spread in the light guide plate uniformly, and periphery of the light guide plate is disposed with light sensor to detect the light generated by the light source. When an object contacts surface of the light guide plate, the total reflective propagation done by light in the light guide plate is frustrated to result in the light passing through contact zone is attenuated; a microprocessor is employed to determine position of the object with triangulation according to the light sensor array detecting attenuated signal of the respective light emitted from at least two light sources disposed at different locations.

US Patent Application Publication No. 2011/0074735 discloses a device detecting the locations of a plurality of objects on a touch surface with which input scanner arrangement introduces at least three beams of radiations into the panel for propagation by internal reflection, and sweeps the beams inside the panel across a sensing area; at least one radiation detector is arranged to receive the beams; a data processor is connected to the radiation detector and operated to identify the locations based on an attenuation of the beam caused by the objects touching the touch surface within the sensing area; the attenuation is identifiable from an output signal of the radiation detector; each output signal generates a transmission signal by dividing the output signal by a background signal which represents the output signal without any object on the touch surface.

US Patent Application Publication No. 2013/0044073 discloses a touch sensing device which comprises a panel configured to conduct signals from a plurality of peripheral out-coupling points to define actual detection lines between pairs of in-coupling and out coupling points to extend across a surface portion of the panel; the signals may be in the form of light, and objects touching the surface portion may affect the light via frustrated total internal reflection; a signal generator is coupled to the in-coupling points to generate the signals; a signal detector is coupled to the out-coupling points to generate the output signal; a data processor operates on the output signal to enable identification of touching objects.

Further, US Patent Application Publication Nos. 2012/0162144, 2012/20268403, and 2013/0021300 are related to touch-control technique employing the light guide plate as well.

The touch-control technique employing the light guide plate disclosed in the preceding references needs that lights emitted from at least two light sources are guided into the light guide plate to proceed total reflective propagation, and utilizes a processor to determine position of an object touching the light guide plate and generate a corresponding touch signal according attenuated signals of the lights emitted from the at least two light sources detected by at least two light sensor arrays.

### SUMMARY OF THE INVENTION

In order to improve the conventional light guide plate touch device, the present invention is proposed.

The primary object of the present invention is to provide a light guide plate touch device with which light emitted by only one light emitting unit is guided into the light guide plate to proceed the total reflective propagation; then, the microprocessor detects the signals received by all the sensitive units, compares the signals to confirm the attenuated signals of the FTIR resulting from the object touching the light guide plate and then to confirm at least two sensitive units which sense the attenuated signals, obtains position information of the touch point where the object touches the upper surface of the light guide plate, and outputs a corresponding touch signal such that the respective number of the light sources and the sensitive units can be reduced substantively to lower the production expenses and save the cost tremendously.

Another object of the present invention is to provide a light guide plate touch device with which only one light scan unit is necessary with scanning light being guided into the light guide plate to proceed the total reflective propagation; the microprocessor detects multiple signals sensed by the sensitive unit next to the light emitting unit within a scanning period of the light scan unit, compares the signals to confirm attenuated signals of the FTIR resulting from the object touching the light guide plate and then to confirm the attenuated signals sensed by the sensitive unit being at least at two time points within the scanning period of the light scan unit, obtains the position information of the touch point where the object touches the upper surface of the light guide plate according to the at least two time points, and outputs a corresponding touch signal such that the respective number of the light sources and the sensitive units can be reduced substantively to lower the production expenses and save the cost tremendously.

A light guide plate touch device according to the present invention comprises:
a light guide plate having an upper surface, a lower surface and a peripheral surface, wherein edges surrounding the light guide plate form the peripheral surface, and the upper surface is parallel to the lower surface to allow light totally reflects and propagates between the upper and lower surfaces;
a microprocessor;
a sensitive unit array having a plurality of sensitive units electrically connecting with the microprocessor respectively;
a light emitting unit electrically connecting with the microprocessor, and being disposed outside the light guide plate and close to an end of the sensitive unit array;
wherein said sensitive unit array contacts one of the peripheral surface and the lower surface; when light emitted by the light emitting unit is guided into said light guide plate and radiates or scans an operation zone simultaneously, part of the light is reflected back to inner side of the light guide via the peripheral surface to shoot said sensitive units while the peripheral surface touched by the light has no contact with the sensitive unit array; at the time of no object touching the upper surface within the operation zone, all the sensitive units sense normal signals; at the time of an object proceeding touch-control work in the operation zone, total reflective propagation of the light in the light guide plate is frustrated and the light passing through touch area of the object is attenuated so as to allow the sensitive units to sense attenuated signals corresponding to the light passing through the touch area of the object; the microprocessor detects multiple signals received by the sensitive units, compares the signals to confirm attenuated signals of the frustrated total internal reflection resulting from the object touching the light guide plate and then to confirm the attenuated signals being sensed by at least two sensitive units, obtains position information of the touch point where the object touches the upper surface of the light guide plate, and outputs a corresponding touch signal.

A light guide plate touch device according the present invention comprises:
a light guide plate having an upper surface, a lower surface and a peripheral surface, wherein edges surrounding the light guide plate form the peripheral surface, and the upper surface is parallel to the lower surface to allow light totally reflects and propagates between the upper and lower surfaces;
a microprocessor;
at least a sensitive unit electrically connecting with the microprocessor;
a light scan unit electrically connecting with the microprocessor, and being disposed outside the light guide plate next to said sensitive unit;
at least an elongated retro reflector contacting the peripheral surface;
wherein said sensitive unit contacts the peripheral surface or the lower surface; when light emitted by the only light scan unit is guided into said light guide plate to scan an operation zone, part of the light is reflected back to inner side of the light guide via the peripheral surface while the light touches the peripheral surface where there is no contact with the retro reflector, and the light reaching the retro reflector shoots back to the light scan unit and the sensitive unit via original path; at the time of no object touching the upper surface in the operation zone, the sensitive unit senses normal signal within a scanning period of the light scan unit; at the time of an object touching the upper surface of the light guide plate in the operation zone to proceed touch-control work, the total reflective propagation of the light in the light guide plate is frustrated and the light passing through touch area of the object is attenuated so as to allow the sensitive unit to sense an attenuated signal within the scan period of the light scan unit corresponding to the light passing through the touch area of the object; the microprocessor detects signals sensed by the sensitive unit within the scanning period of the light scan unit, compares the signals to confirm the attenuated signal of the frustrated total internal reflection resulting from the object touching the light guide plate and confirm the attenuated signal sensed by the sensitive unit at least at two time points within the scanning period of the light scan unit, obtains information of position of a touch point on the upper surface where the object touches the guide light plate according to the at least two time points, and outputs a corresponding touch signal.

### BRIEF DESCRIPTION OF THE DRAWINGS

FIG. 1 is a top view of the first embodiment of a light guide plate touch device according to the present invention illustrating the touch device touched by an object;

FIG. 2 is a plan view illustrating light propagating in the first embodiment of a light guide plate touch device according to the present invention;

FIG. 3 is a plan view illustrating light propagating in the second embodiment of a light guide plate touch device according to the present invention;

FIG. 4 is a top view of the fourth embodiment of a light guide plate touch device according to the present invention illustrating the touch device touched by an object;

FIG. 5 is a plan view illustrating light propagating in the third embodiment of a light guide plate touch device according to the present invention.

### DETAILED DESCRIPTION OF THE INVENTION

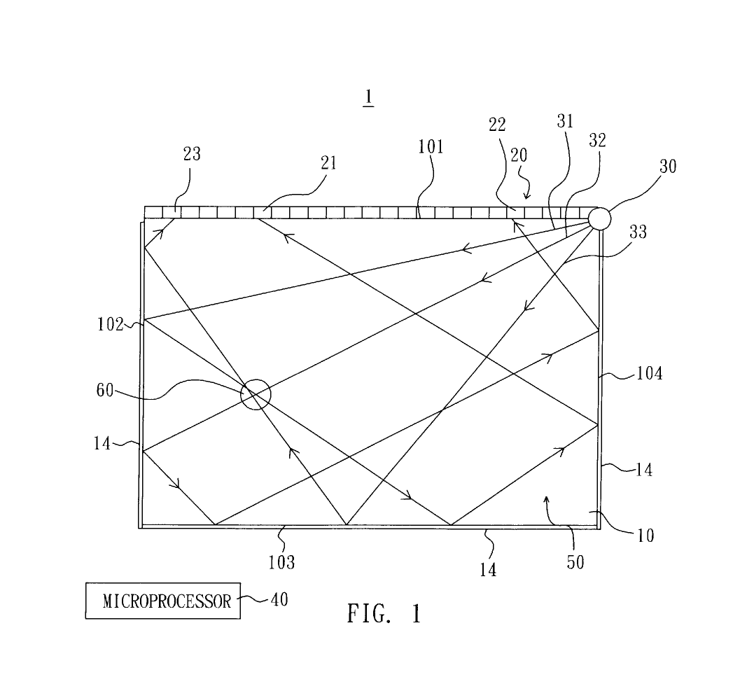

Referring to FIGS. 1 and 2, the first embodiment of a light guide plate touch device according to the present invention is illustrated; the light guide plate touch device 1 comprises a light guide plate 10, a sensitive unit array 20, a light emitting unit 30, and a microprocessor 40; the sensitive unit array 20 and the light emitting unit 30 electrically connect to the microprocessor 40 respectively.

The light guide plate 10 is made of light guide material such as acrylic, resin or glass in a form of bendable or unbendable plate; the light guide plate 10 has an upper surface 11, a lower surface 12, and a peripheral surface 13; the upper and lower surfaces 11, 12, which are parallel to each other, can be flat or curve shapes. Edges of the light guide plate 10 form the peripheral surface 13.

The sensitive unit array 20 is a row of multiple sensitive units 21, 22, 23; the sensitive units 21, 22, 23 can be photodiodes or any other sensitive components. The light emitting unit 30 can be a LED light source, or a LASER light source to emit visible light or invisible light such as infrared, or a LED light or LASER light scan unit to emit visible light or invisible light such as infrared to scan an operation zone. The light emitting unit 30 can be a light source to emit modulated signal, and the modulated signal can be a signal of frequency, amplitude or phase. The light scan unit 30 includes a light source and a device scanning the light emitted from the light source, for instance, includes a turn mirror or includes a MEMS (Micro-Electro-Mechanical System) and a MPEMS ((Micro-Photo-Electro-Mechanical System).

The light guide plate 10 in the first embodiment of the present invention is rectangular with four sides 101, 102, 103, and 104; an operation zone 50 is formed among the four sides. The sensitive unit array 20 has an end next to the light emitting unit 30; the sensitive unit array 20 touches the peripheral surface 13 of the light guide plate 10 and is disposed outside one of the sides which is the side 101 of the light guide plate 10 shown in the figures. The light emitting unit 30 is disposed outside one of corners of the light guide plate 10.

Lights 31, 32, 33 simultaneously emitted from the light emitting unit 30 or sequentially scanned and radiated out from the light emitting unit 30 are guided into the light guide plate 10 via the peripheral surface 13 to irradiate or scan the entire operation zone 50. The lights 31, 32, 33 totally reflect and propagate between the upper surface 11 and the lower surface 12. When the lights touch the peripheral surface 13 at the three sides 102, 103, 104, portions of the lights are reflected into the light guide plate 10 by the peripheral surface 13 to shoot the sensitive units 21, 22, 23 of the sensitive unit array 20. The peripheral surface 13 where there is no contact with the sensitive unit array 20 can be adhered a reflective film 14 to enhance effect of reflection during the lights touching the peripheral surface 13 at the sides 102, 103, 104.

When no object 60 touches the upper surface 11 of the light guide plate 10 in the operation zone 50, all the sensitive units 21, 22, 23 of the sensitive unit array 20 sense normal signals.

When an object 60 such as a finger touches the upper surface 11 of the light guide plate 10 in the operation zone 50 to proceed touch-control work, the total reflections of the lights propagating in the light guide plate 10 are frustrated to result in the lights 31, 32, 33 passing through contact area of the object 60 being attenuated so as to cause that the sensitive units 21, 22, 23 sense attenuated signals corresponding to the lights 31, 32, 33 passing through contact area of the object 60.

The microprocessor 40 detects the signals received by all the sensitive units of the sensitive unit array 20, compares the signals to confirm attenuated signals of the frustrated total internal reflection (FTIR) resulting from the object 60 touching the light guide plate 10 and then confirm the attenuated signals being sensed by the sensitive units 21, 22, 23, obtains position information of a touch point on the upper surface 11 where the object 60 touches the guide light plate 10 according to positions of the sensitive units 21, 22, 23 which sense the attenuated signals, and outputs a corresponding touch signal.

It can be tested and recorded the position information of the touch point where the object 60 contacts the upper surface 11 of the light guide plate 10 and the position information of the sensitive units 21, 22, 23 which sense the attenuated signals such that the microprocessor 40 can obtain the position information of the touch point where the object contacts the upper surface 11 of the light guide plate 10 according to the related information and the positions of the sensitive units 21, 22, 23.

The light guide plate 10 can be a shape other than the rectangular shape. The operation zone 50 can be a portion of the upper surface 11 of the light guide plate 10 instead of the entire upper surface 11.

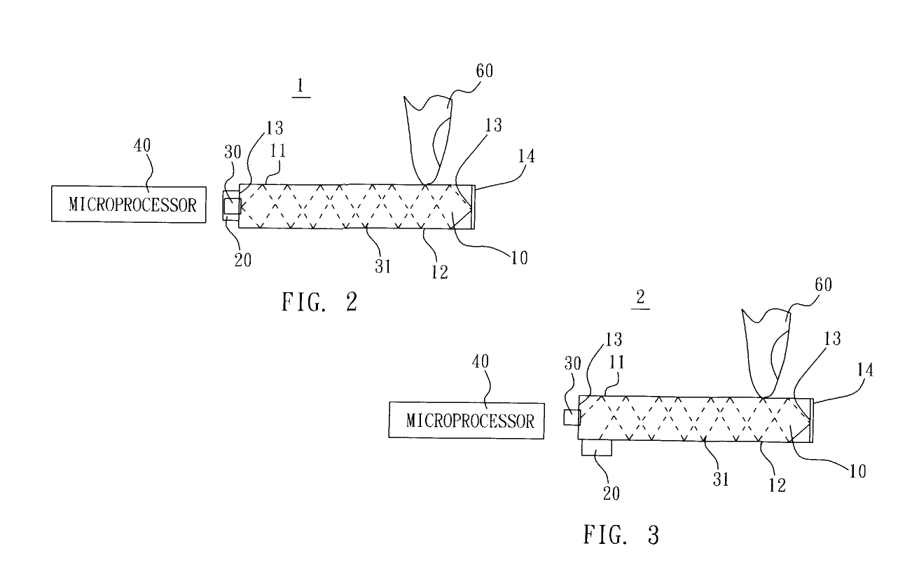

Referring to FIG. 3, the second embodiment of the light guide touch device according to the present invention is illustrated; the light guide plate touch device 2 comprises a light guide plate 10, a sensitive unit array 20, a light emitting unit 30, and a microprocessor 40.

The light guide touch device 2 of the present embodiment is different from the first embodiment in that the sensitive unit array 20 is disposed under the light guide plate 10 to contact the lower surface 12 thereof. Except above-said difference, the structure of the light guide touch device 2 of the second embodiment and the function thereof are the same as the light guide touch device 1 of the first embodiment, and no details will be described further.

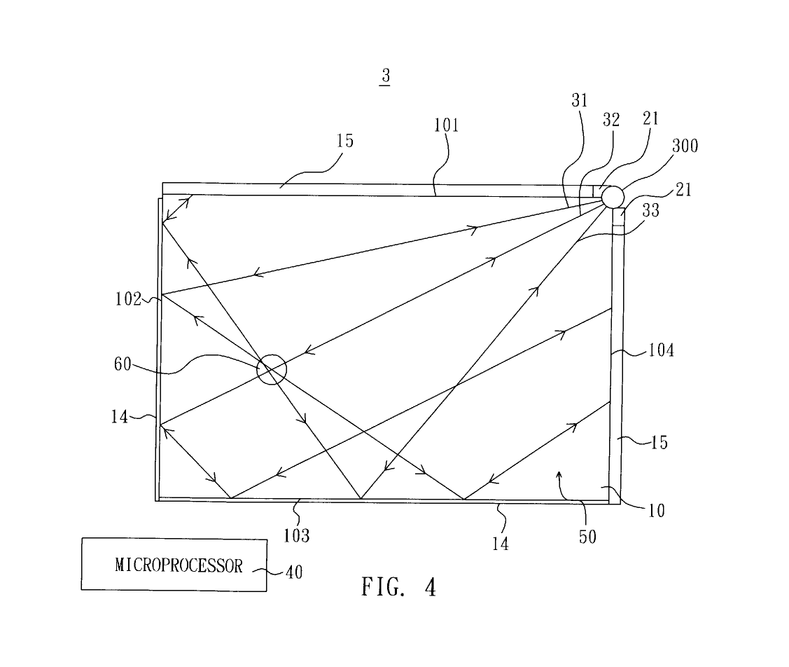

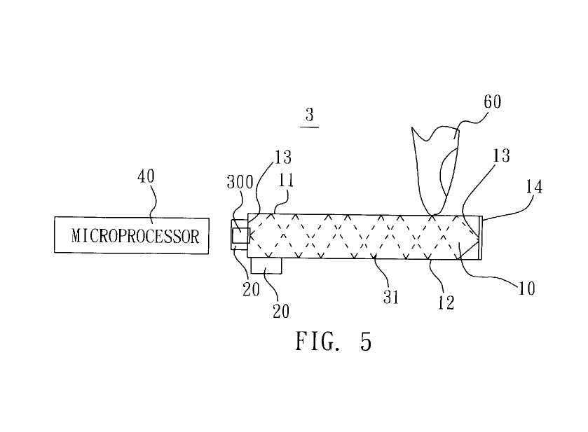

Referring to FIGS. 4 and 5, the third embodiment of the light guide plate touch device is illustrated; the light guide plate touch device 3 comprises a light guide plate 10, at least a sensitive unit 21, a light scanning unit 300, a microprocessor 40 and at least a retro reflector 15.

The light guide plate 10 of the present embodiment is identical with the light guide plate 10 shown in FIG. 1. The sensitive unit 21 and the light scanning unit 300 are electrically connected to the microprocessor 40 respectively.

The light scan unit 300 is disposed at one of the corners of the light guide plate 10 to emit light to scan the entire operation zone 50. There are two sensitive units 21 being shown next to the light scan unit 300 and contacting the light guide plate 10 at least at one of the peripheral surface 13 and the lower surface 12.

There are two elongated retro reflectors 15 disposed to contact the light guide plate 10 and correspond to the two sides 101, 104 on the peripheral surface 13. It is also can be arranged with one elongated retro reflector 15 only instead of two to contact the light guide plate 10 and correspond to one of the two sides 101, 104 on the peripheral surface 13; or the only elongated retro reflector 15 is disposed to be opposite to the sensitive units 21, and, for instance, it can be disposed to contact the peripheral surface 13 to correspond to the side 102 or the side 103 of the light guide plate 10.

The lights 31, 32, 33, which are scanned and radiated sequentially by the light scan unit 300, are guided into the light guide plate 10 respectively via the peripheral surface 13 and scan the entire operation zone 50. The lights 31, 32, 33 totally reflect and propagate between the upper surface 11 and the lower surface 12. When the lights touch the peripheral surface 13 at the two sides 102, 103, portions of the lights are reflected back to inside the light guide plate 10 by the peripheral surface 13; the lights 31, 32, 33, which shoot the retro reflector 15 and are reflected back to the light scan unit 300 along original paths, may shoot the sensitive units 21 near the light scan unit 300 due to light itself having a property of spread during propagation. The peripheral surface 13 where there is no contact with the sensitive unit array 20 can be adhered with a reflective film 14 to enhance effect of reflation during the lights touching the peripheral surface 13.

When no object 60 touches the upper surface 11 of the light guide plate 10 in the operation zone 50, the sensitive unit 21 senses normal signal within a scanning period of the light scan unit 300.

When an object 60 such as a finger touches the upper surface 11 of the light guide plate 10 in the operation zone 50 to proceed the touch-control work, the total reflections of the lights during propagation in the light guide plate 10 are frustrated to result in the lights 31, 32, 33 passing through contact area of the object 60 being attenuated so as to cause that the sensitive unit senses attenuated signals within the scanning period of the light scan unit 21.

The microprocessor 40 detects the signals sensed by the sensitive unit 21 within a scanning period of the light scan unit 300, compares the signals to confirm attenuated signals of the frustrated total internal reflection (FTIR) resulting from the object 60 touching the light guide plate 10 and confirm the sensitive unit 21 sensing the attenuated signals at least at two time points within the scanning period of the light scan unit 300, obtains position information of a touch point on the upper surface 11 where the object 60 touches the guide light plate 10 according to the at least two time points, and outputs a corresponding touch signal.

It can be tested and recorded the position of the touch point where the object 60 contacts the upper surface 11 of the light guide plate 10 and related information of the sensitive unit 21 sensing the attenuated signals at least at two time points within a scanning period of the light scan unit 300, and then the microprocessor 40 obtains the position information of the touch point where the object contacts the upper surface 11 of the light guide plate 10 according to the related information and the sensitive unit 21 sensing the corresponding the attenuated signals at least at the two time points within a scanning period of the light scan unit 300.

The touch-control technique of the light guide plate is employed in the present invention, and the light emitted by only one light emitting unit is guided into the light guide plate to proceed the total reflective propagation; further, the microprocessor detects the multiple signals received by all the sensitive units, compares the signals to confirm the attenuated signals of the FTIR resulting from the object touching the light guide plate and then to confirm at least two sensitive units which sense the attenuated signals, obtains the position information of the touch point where the object touches the upper surface of the light guide plate, and outputs a corresponding touch signal; alternatively, the microprocessor detects the signals sensed by the sensitive unit next to the light emitting unit within a scanning period of the light scan unit, compares the signals to confirm the attenuated signals of the FTIR resulting from the object touching the light guide plate and then to confirm the sensitive unit sensing the attenuated signals at least two time points within a scanning period of the light scan unit, obtains the position information of the touch point where the object touches the upper surface of the light guide plate according to the at least two time points, and outputs a corresponding touch signal. Accordingly, the respective number of the light sources and the sensitive units can be reduced substantively to lower production expenses and save cost tremendously.

Although the invention has been described in relation to its preferred embodiments, it is to be understood that many other possible modifications and variations can be made without departing from the spirit and scope of the invention as hereinafter claimed.

What is claimed is:

1. A light guide plate touch device, comprising:
a light guide plate having an upper surface, a lower surface and a peripheral surface, wherein edges surrounding the light guide plate form the peripheral surface, and the upper surface is parallel to the lower surface to allow light totally reflects and propagates between the upper and lower surfaces;
a microprocessor;
a sensitive unit array having a plurality of sensitive units electrically connecting with the microprocessor respectively;
a light emitting unit electrically connecting with the microprocessor, and being disposed outside the light guide plate and close to an end of the sensitive unit array;
wherein said sensitive unit array contacts the peripheral surface or the lower surface; when light emitted by the only light emitting unit is guided into said light guide plate and simultaneously radiates or scans an operation zone, a portion of the light is reflected back to inner side of the light guide via the peripheral surface to shoot said sensitive units while the peripheral surface touched by the light has no contact with the sensitive unit array; at the time of no object touching the upper surface within the operation zone, all the sensitive units sense normal signals; at the time of an object proceeding touch-control work in the operation zone, total reflective propagation of the light in the light guide plate is frustrated and the light passing through touch area of the object is attenuated so as to allow the sensitive units to sense attenuated signals corresponding to the light passing through the touch area of the object; the microprocessor detects multiple signals received by the sensitive units, compares the signals to confirm the attenuated signals of the frustrated total internal reflection resulting from the object touching the light guide plate and then to confirm at least two sensitive units which sense the attenuated signals, obtains position information of a touch point where the object touches the upper surface of the light guide plate, and outputs a corresponding touch signal.

2. The light guide plate touch device as defined in claim 1 wherein the peripheral surface of the light guide plate where the sensitive unit array does not contact with is adhered a reflective film.

3. The light guide plate touch device as defined in claim 2 wherein the light guide plate is made of light guide material in a form of bendable or unbendable plate.

4. The light guide plate touch device as defined in claim 3 wherein light guide plate is rectangular, the light emitting unit is disposed outside one of corners of the light guide plate, and light emitted from the light emitting unit is guided into the light guide plate via the peripheral surface.

5. The light guide plate touch device as defined in claim 4 wherein the sensitive units are photodiodes; the light emitting unit is a LED light source, or a LASER light source.

6. A light guide plate touch device, comprising:
a light guide plate having an upper surface, a lower surface and a peripheral surface, wherein edges surrounding the light guide plate form the peripheral surface, and the upper surface is parallel to the lower surface to allow light totally reflects and propagates between the upper and lower surfaces;
a microprocessor;
a sensitive unit array having a plurality of sensitive units electrically connecting with the microprocessor respectively;
at least a sensitive unit electrically connecting with the microprocessor;
a light scan unit electrically connecting with the microprocessor, being disposed outside the light guide plate next to said sensitive unit;
at least an elongated retro reflector contacting the peripheral surface;
wherein said sensitive unit contacts the peripheral surface or the lower surface; when light emitted by the only light scan unit is guided into said light guide plate to scan an operation zone, a portion of the light is reflected back to inner side of the light guide via the peripheral surface while the light touches the peripheral surface where the retro reflector does not contact with, and the light radiating the retro refractor shoots back to the light scan unit and the sensitive unit via original path; at the time of no object touching the upper surface in the operation zone, the sensitive unit senses normal signal within a scanning period of the light scan unit; at the time of an object proceeding touch-control work to touch the upper surface of the light guide plate in the operation zone, total reflective propagation of the light in the light guide plate is frustrated and the light passing through touch area of the object is attenuated so as to allow the sensitive unit to sense an attenuated signal within the scan period of the light scan unit corresponding to the light passing through the touch area of the object; the microprocessor detects multiple signals sensed by the sensitive unit within a scanning period of the light scan unit, compares the signals to confirm attenuated signals of the frustrated total internal reflection resulting from the object touching the light guide plate and confirm the sensitive unit sensing the attenuated signals at least at two time points within the scanning period of the light scan unit, obtains position information of a touch point on the upper surface where the object touches the guide light plate according to the at least two time points, and outputs a corresponding touch signal.

7. The light guide plate touch device as defined in claim 6 wherein the peripheral surface of the light guide plate where the sensitive unit array does not contact with is adhered a reflective film.

8. The light guide plate touch device as defined in claim 7 wherein the light guide plate is made of light guide material in a form of bendable or unbendable plate.

9. The light guide plate touch device as defined in claim 8 wherein the light guide plate is rectangular, the light emitting unit is disposed outside one of corners of the light guide plate, and light emitted from the light emitting unit is guided into the light guide plate via the peripheral surface; the peripheral surface contacts two retro reflectors respectively.

10. The light guide plate touch device as defined in claim 9 wherein the sensitive units are photodiodes; the light emitting unit is a LED light source, or a LASER light source.
